(19) United States
(12) Patent Application Publication
(10) Pub. No.: US 2008/0103837 A1
(43) Pub. Date: May 1, 2008

(54) RISK REDUCTION FOR PARTICIPANTS IN AN ONLINE ADVERTISING EXCHANGE

(75) Inventors: Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US); Brian Burdick, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/748,333

(22) Filed: May 14, 2007

Related U.S. Application Data
(60) Provisional application No. 60/862,969, filed on Oct. 25, 2006.

(51) Int. Cl. G06Q 40/00

(52) U.S. Cl. 705/4

(57) ABSTRACT

For a multi-party advertising exchange including advertising and publishing entities from disparate advertising networks, a framework is provided for applying insurance terms to advertising transactions in the exchange, enabling risk sensitive participants to ease their participation in a potentially volatile online advertising marketplace. Participants can use the insurance mechanism of the advertising exchange to reduce variance in expected outcome for transactions in the advertising exchange.

### CROSS REFERENCE TO RELATED APPLICATIONS

This application claims priority to U.S. patent application Ser. No. 60/862,969, filed on Oct. 25, 2006, entitled “DISTRIBUTED ARCHITECTURES FOR ONLINE ADVERTISING”, the entirety of which is incorporated herein by reference.

### TECHNICAL FIELD

For online advertising architectures and environments, the subject disclosure relates to the reduction of risk for participants in online advertising markets to encourage greater overall participation.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

Given all the lack of uniformity across all the data, among other uncontrollable factors in supply or demand, such advertising systems leave participants with little certainty when conducting advertising transactions in such a noisy and volatile online advertising marketplace. Participants may wish to advertise and enter into the advertising network, except that the sheer uncertainty of whether there will be a return on their investment may keep them from entering into such transaction.

For instance, consider a mortgage broker advertiser that counts on gaining X number of customers a month to make money. When it comes to advertising, as a commodity service provider, the mortgage broker will be most interested in gaining customers, regardless of impact on any quality score maintained for the mortgage broker, and so spending advertiser dollars without results can be costly to the bottom line.

Consider, on the other hand, an expensive Italian watch and jewelry maker who may not care about making a sale at the moment of on-line advertising, but is more interested in preserving brand value. Such a jewelry maker would be disconcerted greatly by being associated with low quality publishing, such as pornography.

The risk attendant to the mortgage broker or jewelry maker when transacting in the advertising network if one or more downsides should manifest creates a barrier to some participants without risk tolerance, introducing unnecessary business stress. Thus, what is desired is a way for participants in an advertising exchange to identify and reduce risk for mitigation in an advertising transaction. It would be further desirable to be able to automatically generate insurance terms that apply to transactions for purchase by any participant to a transaction to address the risk profiles of the respective participants.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising and publishing entities from disparate advertising networks, the invention includes a framework for applying insurance terms to advertising transactions in the exchange, enabling risk sensitive participants to ease their participation in a potentially volatile online advertising marketplace. In various non-limiting embodiments provided in accordance with the invention, participants can use an insurance mechanism enabled by an advertising exchange to reduce variance in expected outcome for transactions in the advertising exchange.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the risk reduction for participants in an online advertising in accordance with the present invention are further described with reference to the accompanying drawings in which:

FIGS. 1A and 1B illustrate exemplify risk that is inherent in online advertising exchanges in accordance with insurance terms provided in accordance with the invention;

FIG. 2A illustrates an exemplary insurance services layer introduced to an online advertising exchange in accordance with the invention;

FIG. 2B illustrates an exemplary insurance services layer on the buy side and an exemplary insurance services layer on the sell side introduced to an online advertising exchange in accordance with the invention;

FIG. 3 illustrates an exemplary framework for automatically providing insurance services as part of advertising transactions in an exchange in accordance with the invention;

FIG. 4 illustrates exemplary transformation of constraints on exchange participation to insurance terms in accordance with the invention;

FIG. 5 illustrates exemplary support provided to participants as part of selecting an appropriate set of insurance terms for transactions conducted in an exchange in accordance with the invention;

FIG. 6 is a flow diagram exemplifying the generation of insurance instruments based on risk expressions received from participants by an exchange in accordance with the invention;

FIG. 7 is an exemplary, non-limiting block diagram showing dynamic decision support for participants to an online advertising exchange in order to bound transactions with appropriate insurance terms in accordance with the invention;

FIGS. 8A and 8B illustrate exemplary performance tracking as a function of insurance terms applied to transactions in an advertising exchange in accordance with the invention;

FIGS. 9A and 9B illustrate exemplary normalization of insurance terms and risk expressions as might be disparately defined by different participants to an advertising exchange in accordance with the invention;

FIG. 10 is a flow diagram illustrating an exemplary, non-limiting process for transacting with an insurance layer in the context of an online advertising auction held by an advertising exchange;

FIG. 11 is a block diagram of a computing system environment suitable for use in implementing the present invention;

FIG. 12 illustrates a distributed architecture for online advertising, according to embodiments of the present invention;

FIG. 13 illustrates one example of the flow of data within an exemplary non-limiting architecture according to embodiments of the present invention;

FIG. 14 illustrates a flowchart of the operation of an exchange, according to exemplary, non-limiting embodiments of the present invention; and

FIG. 15 illustrates a flowchart of the operation of user or a user data broker to provide potentially valuable information according to embodiments of the present invention.

### DETAILED DESCRIPTION

### Overview

In various non-limiting embodiments, the invention is described in the context of a distributed architecture for online advertising, i.e., a market mechanism that manages the exchange of advertising goods among multiple participants on the advertising and/or publishing side, and across disparate advertising networks that today are exclusive of one another as described in the background. In consideration of the limitations on and inherent risk in existing architectures described in the background, the invention provides risk reduction for participants in an advertising exchange by enabling the generation of insurance instruments/terms that apply to one or more transactions among participants in the exchange.

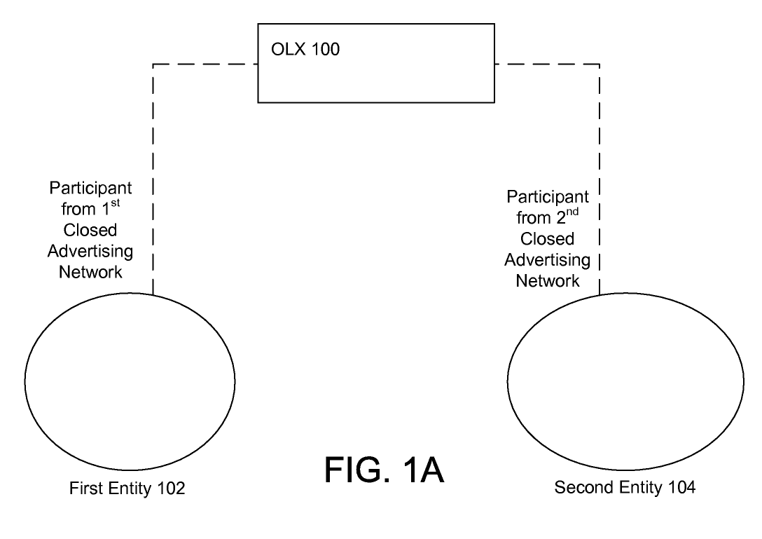

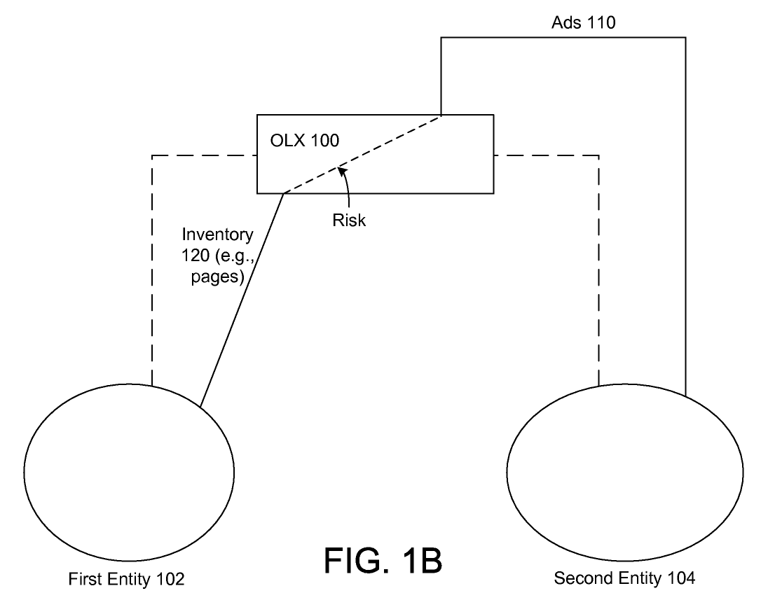

In general, an exchange 100 in accordance with the invention is illustrated in FIG. 1A, including a participant 102, such as an advertiser broker or publisher broker from a first closed advertising network and a participant 104, such as an advertiser broker or publisher broker from a first closed advertising network, who are able to come together via federated advertising exchange 100. Exchange 100 operates to match advertising inventory (e.g., ads) with publisher inventory (e.g., web sites) as part of an online bidding process, completing one or more transactions between buyers and sellers of advertising. More about a federated online advertising exchange, such as exchange 100, as an exemplary implementation environment for the invention is described below. The invention is not limited to entities 102 and 104 to being advertising brokers or publisher brokers, but rather entities 102 and 104 may also be exchanges, whereby exchange 100 becomes an exchange of exchanges.

As shown in FIG. 1B, when a transaction that matches ads 110 from entity 104 and inventory 120 of entity 102 is conducted in exchange 100, a variety of types of risk are inherent in the transaction. In various non-limiting embodiments, the invention automatically generates insurance terms for the various kinds of risk represented in online advertising transactions, such as keyword bidding auctions.

Any participant can thus insure against a variety of types of risk in advertising exchange transactions in a way that is tailored to the goals of the participant, whether on the buy or sell side of an advertising transaction. Optionally, a third party insurance provider can participate in the exchange for the purpose of handling insurance terms applying to transactions in the exchange. Re-insurance and enforcement of insurance terms may also be provided as additional services of the exchange or as third party services in connection with the insurance terms applying to transactions in the exchange in accordance with the invention.

In one embodiment, a wizard or tool is provided to help a participant select insurance terms that meet the participant's objectives and risk profile with respect to transactions in the exchange. Over time, the performance of a participant can be measured over time as a function of insurance terms that apply. For instance, over time, it might be observed that a participant is underinsured and is in effect paying a penalty for being underinsured. In such a case, a tool provided in accordance with the invention can dynamically tune the participant's risk profile so that more optimal insurance terms result, or dynamically change insurance terms for a participant directly.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follows.

### Risk Reduction for Participants of an Advertising Exchange

As mentioned, one of the biggest inhibitors in online advertising auctions is the risk to participants represented by relatively uncertain expected outcomes. The reality is that the marketplace of online advertising performs according to a variety of capricious and uncontrollable factors. At bottom, no one has a crystal ball about how much one should pay for, say, keyword advertising for the name “Britney Spears” because tomorrow, her popularity could drop dramatically. If one's ad campaign depends on the continued success of and performance of the name Britney Spears until the election, e.g., to reach a particular target audience on a regular and ongoing basis for a given period, then one might want to reduce the risk that Britney Spears' popularity decreases drastically.

Thus, what would be of practical value is a way to insure against different kinds of risk represented by advertising transactions, e.g., to insure against the fall in popularity of Britney Spears. Similarly, if one's budget were limited, one might want to limit how popular Britney Spears becomes too to keep advertising costs from escalating. Insurance terms from an insurance provider in accordance with the online advertising insurance framework of the invention are provided to participants to hedge these kinds of risk inherent in advertising transactions. The invention thus provides risk reduction for participants in an advertising exchange by enabling the generation of insurance instruments/terms that apply to one or more transactions among participants in the exchange.

As the above Britney Spears example shows, upper and/or lower bounds may be applied in accordance with insurance terms in accordance with the invention to bound risk at both extremes of an expected outcome. However, the invention is not so limited. In accordance with the invention, any constraint that can be specified on an advertising transaction as a function of a measurable characteristic of the advertising transaction may form the basis for one or more insurance terms offered to a participant in accordance with the insurance layer of an advertising exchange. For instance, to show that any arbitrary function of an advertising transaction characteristic may form the basis of an insurance term in accordance with the invention, one could specify an insurance term that (10−log₂(Volume))/2 not exceed 5.

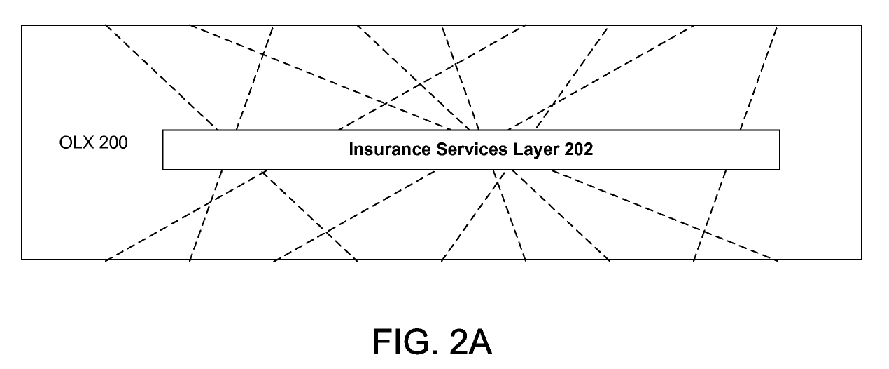

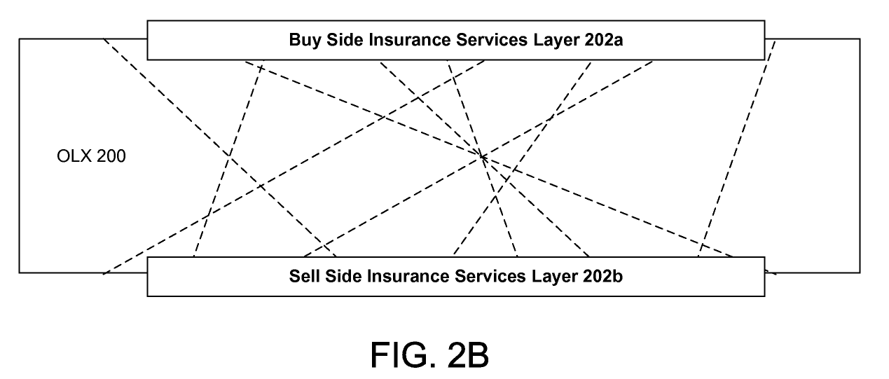

The insurance layer of the present invention is illustrated as layer 202 of an exemplary exchange 200 of FIG. 2A. The dashed lines represent transactions that are being conducted in exchange 200 by participants on an ongoing basis. Insurance layer 202 operates to interface with insurance providers (not shown) who provide insurance terms based on constraints on transactions desired by participants and to interface with the participants who desire the insurance terms. FIG. 2A illustrates that layer 202 can handle and/or enforce insurance contracts defined by potential purchasers (or advertisers). As a result, the transactions that are matched by exchange 200 adhere to the insurance obligations on price, inventory, display characteristics, quality metric, etc. defined by corresponding insurance contracts received by the insurance contract component 1452.

Thus, a form of advertising/spend product is provided in accordance with the invention that is defined as an insurance product. Like options and futures contracts, insurance contracts depend on what might happen in the future, and thus insurance may supplement the offerings of a financial instrument provider that services options or futures instruments for exchange transactions. For another example, an advertiser may agree to purchase advertising at a price of $1/Elmo advertisement conversion from a given supplier for a fixed period of time (e.g., 1 year) as long as the price for a given class of inventory never goes over $2/Elmo advertisement conversion. Such a transaction can be structured as an insurance contract that the price will never exceed $2/Elmo ad conversion. In such a case, the buyer is willing to pay a premium for the guarantee that the price will stay reasonable for a given time period.

In this regard, the invention is not limited to mitigating any particular kind of risk in connection with an online advertising transaction. Some non-limiting examples include mitigating risk with respect to the following characteristics of advertising transactions, both with respect to going too high (upper bound) and with respect to going too low (upper bound): Price, Volume or growth rate, Availability of supply, Availability of demand, Clickthrough rate (CTR), Conversion rate (or any other performance metric), Display properties, Reach, Relevance or Interest Level, etc. Coupling insurance contracts to the advertising display system, for instance, and to the overall architecture enables powerful scenarios.

Thus, in accordance with the invention, a tool is provided in connection with an insurance layer provided in the exchange for participants to set constraint(s) on any kind of risk represented by advertising transactions, whereby insurance terms that are acceptable to an insurance provider are automatically generated for offer to participants based on any constraints specified by the participants.

In one embodiment, a risk profile for participants is derived for participants based on one or more local objectives or utility functions expressed by the participant for overall participation in the exchange. The risk profile enables the exchange to offer insurance terms that are likely to be optimal for that participant's needs.

Any participant can thus insure against a variety of types of risk in advertising exchange transactions in a way that is tailored to the goals of the participant, whether on the buy or sell side of an advertising transaction. FIG. 2B illustrates that the insurance layer for an exchange 200 in accordance with the invention may include a buy side insurance services layer 202a and a sell side insurance services layer 202b. Since layers 202a and 202b serve opposite sides of a transaction, maintaining independence of these layers can be advantageous and keeps insurers from representing two sides of the same transaction, which can be a conflict of interest.

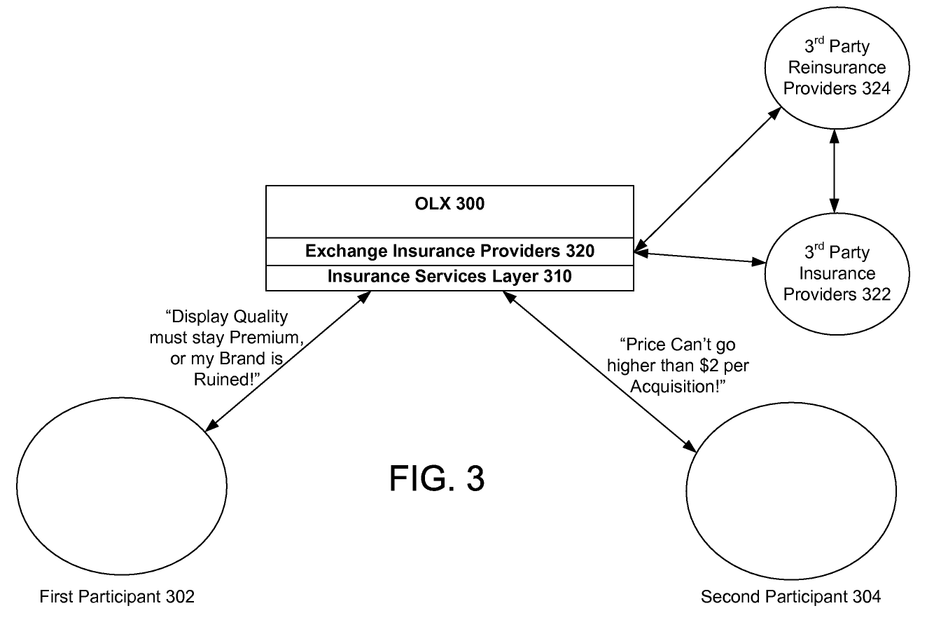

An exemplary architecture for providing insurance terms in accordance with the invention is shown in FIG. 3 including a first participant 302 and a second participant 304 to exchange 300. In accordance with the invention, exchange 300 includes an insurance layer 310, which may include interfaces for communications with internal insurance providers 320 or external insurance providers 322. Insurance providers 320 or 322 thus participate in the exchange for the purpose of handling insurance terms applying to transactions in the exchange 300.

Optionally, re-insurance or enforcement of insurance terms may also be provided as additional services of the exchange 300 or as third party services, such as services 324, in connection with the insurance terms applying to transactions in the exchange in accordance with the invention. Any service that is predicated on the insurance industry is thus also supported in optional embodiments of the invention. One can thus see that the invention has practical value for participants wishing to reduce uncertainty in online advertising transactions.

For instance, first participant 302 might want display quality to remain premium in order to preserve the value of company brand. In this regard, participant 302 can use insurance layer 310 by specifying that constraint to layer 310, which then solicits insurance terms from insurance providers 320 or 322, for offer to the participant 302. The participant 302 accepts the most attractive offer, (or rejects insurance entirely), and the risk needs of participant 302 have thereby been addressed. In this example, one can see that it is not price that forms the basis of the insured outcome.

For an example involving price, second participant 304 might wish to express the constraint on transactions that price can never exceed $2 per acquisition (or express in some other equivalent advertising pricing model). In such case, second participant 304 may also use insurance services layer 310 of the advertising exchange 300 to solicit insurance terms from insurance providers 320 or 322 that address the specified risk.

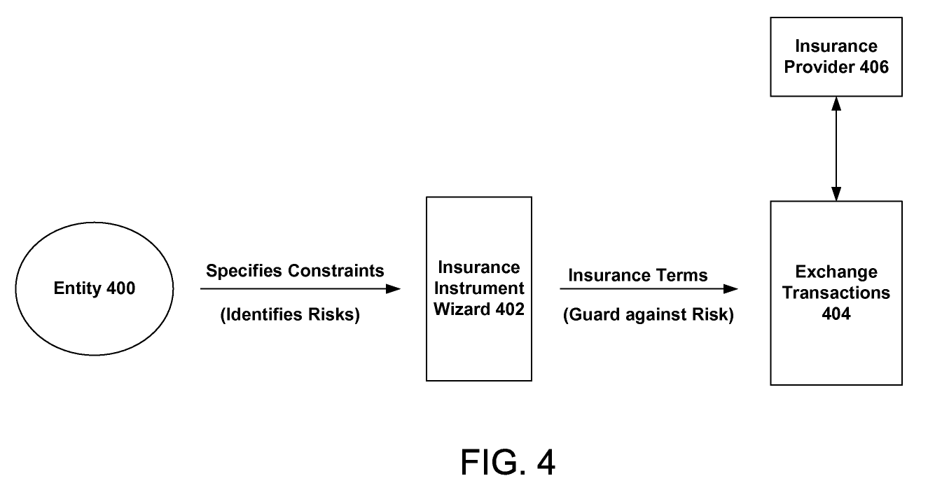

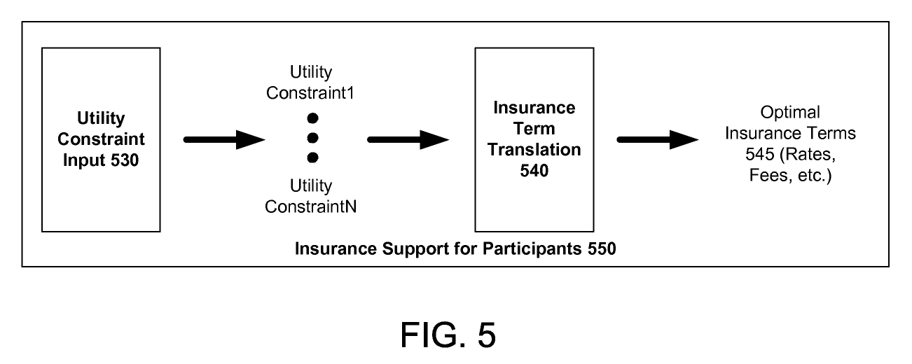

In one embodiment, as shown in FIG. 4, a wizard or tool 402 is provided to help a participant 400 select insurance terms that meet the participant's objectives and risk profile with respect to transactions in the exchange. Thus, initially, participant directly or indirectly specifies constraints on transactions in the exchange that identify risks to the wizard 402, which then translates those risks into desirable insurance terms which are input to the transactions of the exchange 404. These requested insurance terms are then passed along to insurance providers 406 who provide insurance terms that can be offered to entity 400.

In one embodiment, the invention provides a tool 550 that provides insurance terms selection support that is predicated on one or more utility functions 530 expressed by a participant to the exchange. In this regard, each utility function 530 in some way places a limit on the participant's preferences for participation in the exchange according to some objective. These limits can be viewed as constraints constraint1 through constraintN, which can be translated in risk terms to insurance terms by component 540 of tool 550. In this regard, insurance term translation component 540 provides optimal insurance terms 545, i.e., however expressed (rates, fees, etc.), that guard against the risk represented by constraint1 through constraint.

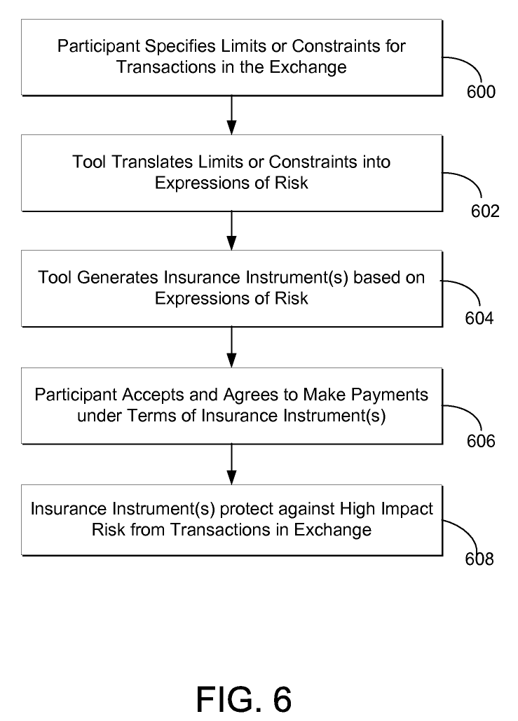

FIG. 6 is a flow diagram of an exemplary non-limiting process for taking advantage of the insurance layer provided for an online advertising exchange in accordance with the invention. At 600, a participant specifies limits or constraints for transactions in the exchange. This can be done directly, e.g., “Nothing but quality of at least X on quality metric scale Y” or “Price not to exceed $X/unit advertising.” Or this can be done indirectly, e.g., “I wish to maximize reach” which implicitly specifies limits on transactions under or over which the participant does not wish to go. Then, at 602, a tool or wizard provided in accordance with the invention translates those limits or constraints into a common language for expressing kinds of risk in advertising transactions. The tool passes the expressions of risk to the exchange, which then generates insurance terms to offer to the participant at 604 by soliciting insurance providers for the given expressions of risk. Then, at 606, the participant accepts (or does not accept) the insurance terms. At 608, if the terms are accepted, the terms apply to transactions in the exchange and the participant has a mechanism to protect against high impact risk, e.g., disaster points.

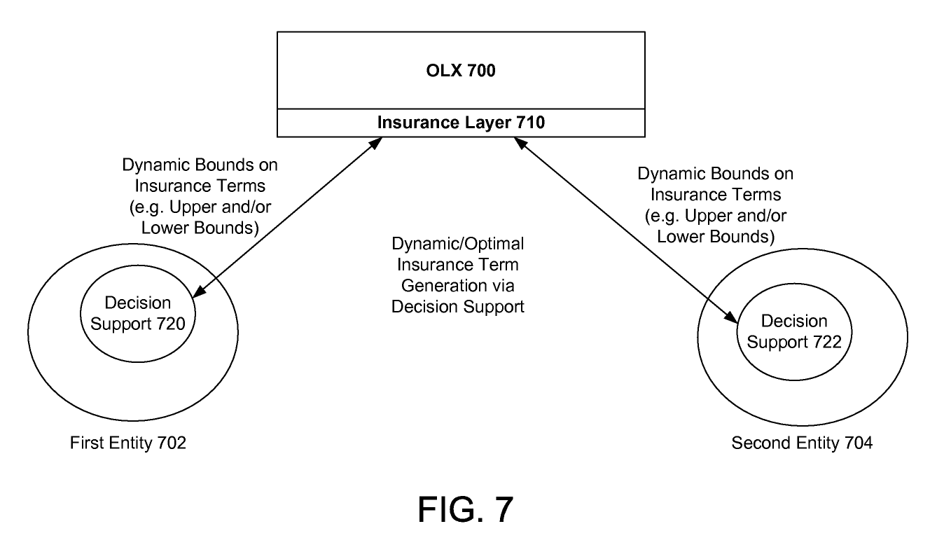

FIG. 7 illustrates exemplary provision of an insurance decision support tool or wizard 720 and 722 for entity 702 and 704, respectively. The decision support tools 720 or 722 help the participants of exchange 700 define bounds on insurance terms for the participants' participation in transactions of the exchange 700. In one embodiment, insurance layer 710 of OLX 700 supports dynamically defined insurance terms, i.e., insurance terms that change when a participant's scope of participation in transactions change, e.g., when the goals of participation change. Thus, it is possible to provide optimal insurance terms and dynamically maintain optimal insurance terms for each participant in the exchange via decision support tools 720 or 722.

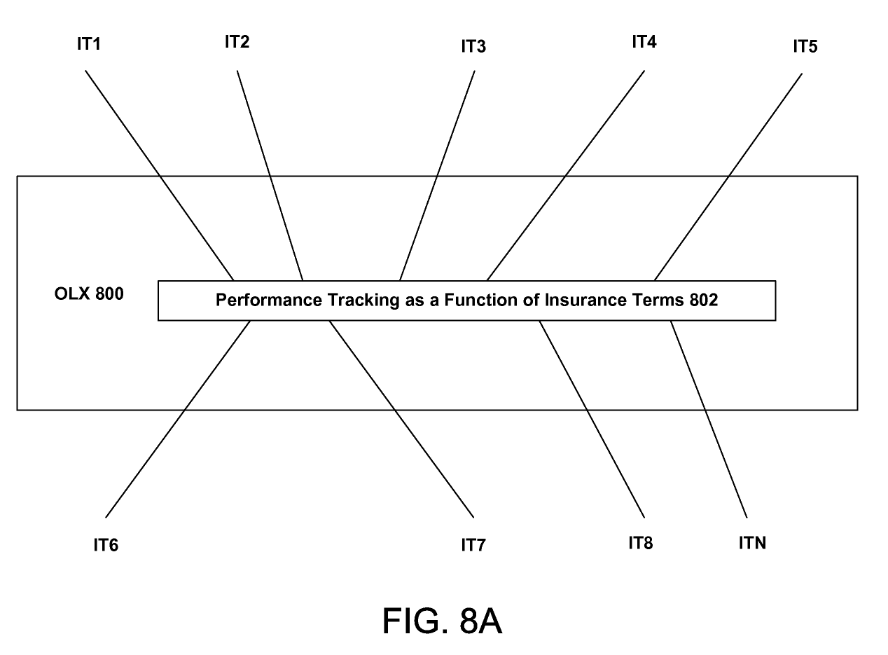

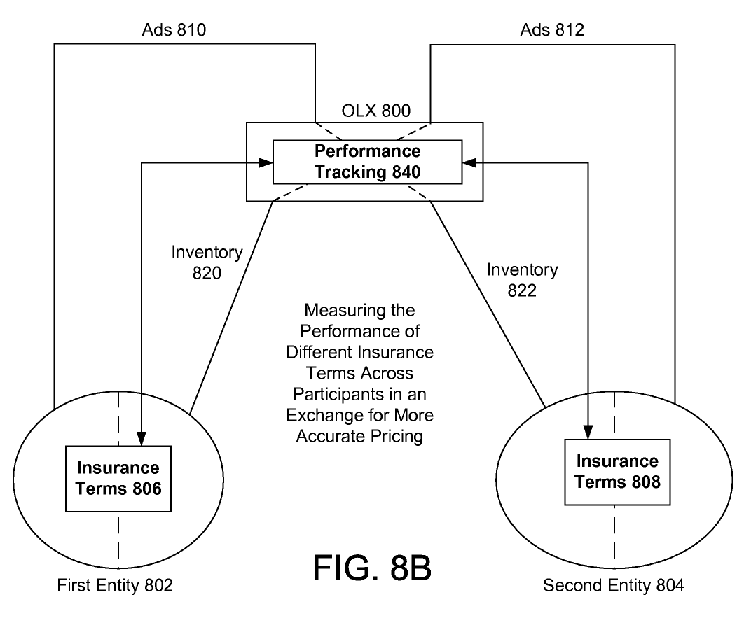

Over time, the performance of a participant can be measured as a function of insurance terms that apply as shown in FIG. 8A. For instance, over time, it might be observed that a participant is underinsured and is in effect paying a penalty for being underinsured. A tracking layer 802 of exchange 800 advantageously maintains performance information about different insurance terms IT1, IT2, IT3, IT4, IT5, IT6, IT7, IT8, . . . , ITN across all of the participants in the marketplace, thereby over time, becoming more knowledgeable about the best insurance terms to offer via the exchange 800. In such a case, a tool in accordance with the invention can dynamically tune each participant's risk profile as a function of evolving preferences and market conditions so that more optimal insurance terms result. The tool or wizard can make changes based on input from the participant, or the tool may dynamically change insurance terms for a participant on the participant's behalf in accordance with a default behavior.

FIG. 8B elaborates on performance tracking component 840 to show the holistic view over the performance of all entities as a function of insurance terms applied to transactions. While only two entities 802 and 804 are shown having insurance terms 806 and 808, respectively, the block diagram conceptually scales to any number of participants. When performance tracking component 840 maintains performance information about how different insurance terms perform for participants' transactions across the entire exchange 800, for all ads 810, 812 and for all inventory 820, 822, more accurate pricing of insurance terms becomes possible, benefiting all. Thus, the performance of insurance contracts handled by the insurance layer of the invention can be tracked in accordance with the invention.

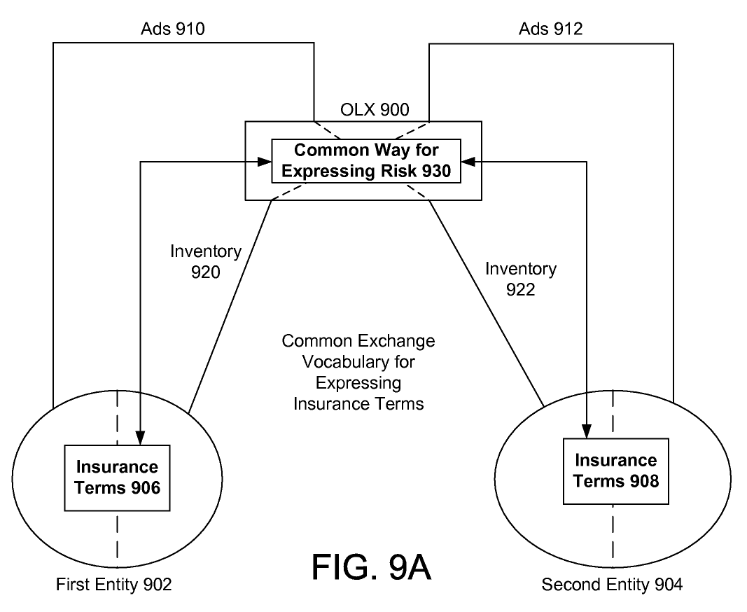

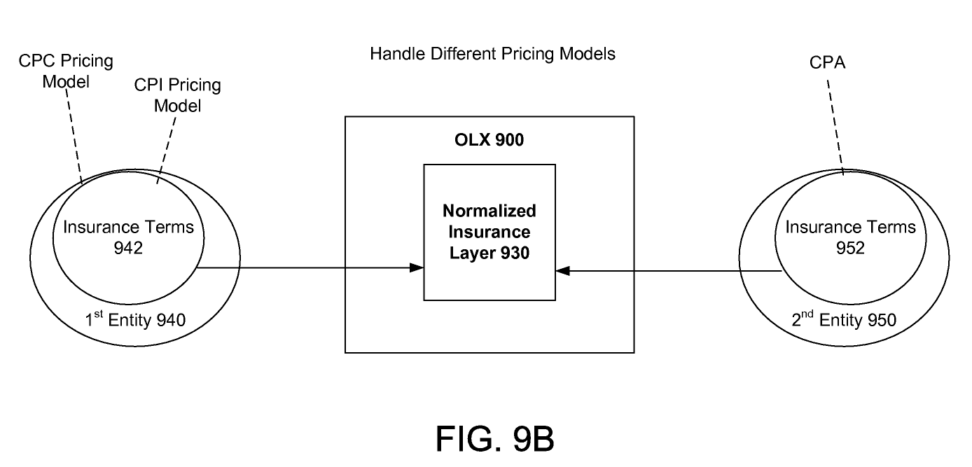

Additionally, as shown in FIG. 9A, insurance contracts can also be normalized and matched to available inventory by the exchange of the present invention. Entities 902 and 904 having insurance terms 906 and 908, respectively, transact for anyone or more of ads 910, inventory 920 and inventory 922, ads 912, respectively. In accordance with the invention, given the number of disparate ways that insurance terms might be expressed by different entities 902 and 904, the insurance layer of the exchange 900 may optionally include a normalizing component 930 that provides a common way for expressing risk and insurance functions within the exchange 900.

As a simple example, FIG. 9B illustrates that there are variety of pricing models that could form the basis for a risk expression, or insurance term, in accordance with the invention. For instance, entity 940 may have insurance terms 942 that include different pricing models, such as a term that specifies an upper limit on quality in terms of a cost per click (CPC) pricing model and another terms that specifies a range within which the participant wishes to stay for a transaction according to a cost per impression (CPI) pricing model. At the same time, insurance terms 952 of yet another party may include terms specified according to a cost per acquisition (CPA) pricing model. Layer 930 of exchange 900 is thus optionally able to translate between the different expressions for a comparison of the different insurance terms.

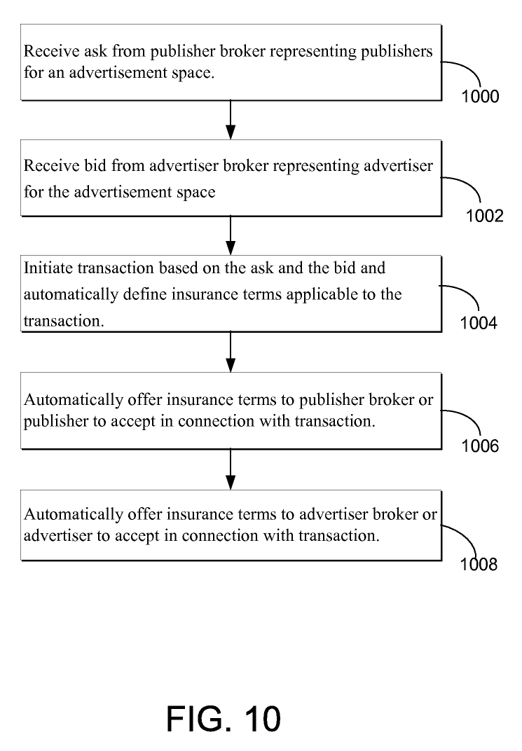

Accordingly, in various non-limiting embodiments, the invention provides systems and methods for facilitating trading of advertising in a federated advertising exchange for disparate networks by reducing risk for transactions. At 1000, FIG. 10 shows a publisher broker submitting an ask for an advertisement space. At 1002, an advertiser broker submits a bid for the advertisement space. At 1004, one or more transactions are initiated and insurance terms are automatically dictated based on risk expressions from the participants to the transactions. At 1006, the insurance terms are automatically offered to the publishing side according to a publisher insurance layer. At 1008, the insurance terms are automatically offered to the advertising side according to an advertiser insurance layer.

### Exemplary Operating Environment(s)

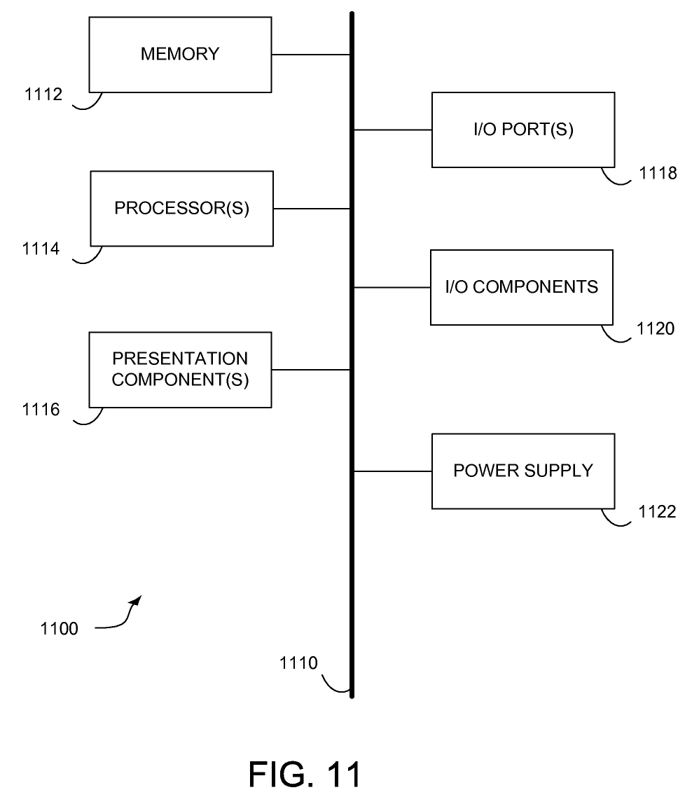

Referring initially to FIG. 11 in particular, an exemplary operating environment for implementing embodiments of the present invention is shown and designated generally as computing device 1100. Computing device 1100 is but one example of a suitable computing environment and is not intended to suggest any limitation as to the scope of use or functionality of the invention. Neither should the computing-environment 1100 be interpreted as having any dependency or requirement relating to any one or combination of components illustrated. In accordance with the invention, participants can communicate with an advertising exchange via one or more computing devices 1100, and the advertising exchange may also comprise one or more computing devices 1100, in order to carry out one or more aspects of the invention described in detail below.

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 11, computing device 1100 includes a bus 1110 that directly or indirectly couples the following elements: memory 1112, one or more processors 1114, one or more presentation components 1116, input/output ports 1118, input/output components 1120, and an illustrative power supply 1122. Bus 1110 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 11 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 1100.

Memory 1112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which may be built in. Illustrative components include a microphone, joystick, game pad, satellite dish, scanner, printer, wireless device, etc.

### Exemplary Architecture(s) for Online Advertising

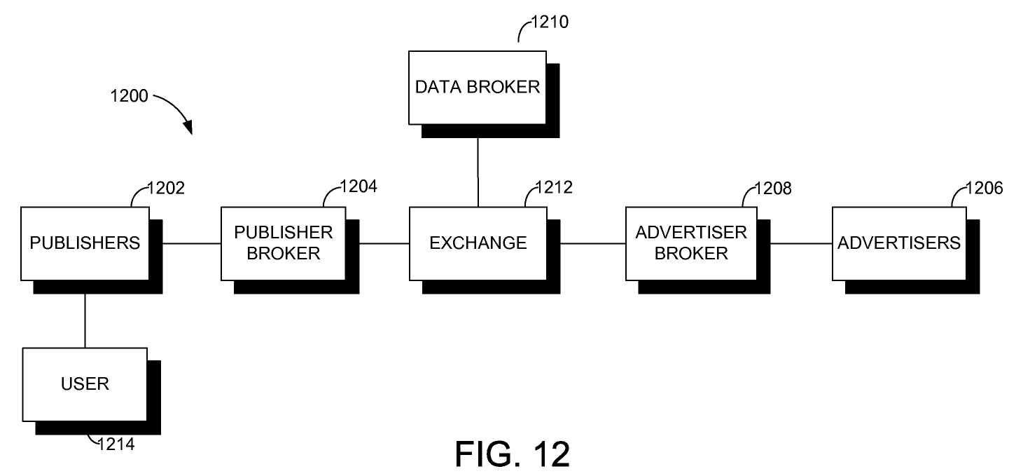

Exemplary online advertising environments or architectures in which one or more of the various embodiments of the specification and normalization of participant tax rates, and intelligent automation of tax rate selection of the present invention may be deployed or implemented are now described. For instance, FIG. 12 illustrates an exemplary distributed architecture 1200 for online advertising, which comprises publishers 1202. For purposes of explanation only, publishers 1202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 1200.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 1202 is intended to represent any number of types, sizes, sophistication levels, etc. of publishers. Size of participants in the exchange can be determined by any method for assigning a size to an entity in a transaction. For instance, size can be determined as a function of revenue or income of the participant, a function of the number of employees of the participant, a function of annual advertising expenditure, a function of growth rate, and so on, as well as a combination of any of the foregoing, i.e., any metric that tends to indicate influence of a participant based on relative size can be used. In an embodiment, publishers 1202 desire to sell advertisement space on their websites to advertisers 1206 (discussed below).

Architecture 1200 also comprises publisher broker 1204. For purposes of explanation only, only one publisher broker will be discussed herein. However, embodiments of the present invention are not limited to a single publisher broker, as any number of publisher brokers may exist. In an embodiment, publisher broker 1204 is an aggregator of publishers. Specifically, publisher broker 1204 is an entity that represents publishers 1202 with the goal of maximizing ad revenue, ensuring quality ads, etc. Publisher broker 1204 breaks the conflict of interest that is inherent in systems such as Google's AdSense by solely focusing on managing publishers 1202's yield. Publisher broker 1204 allows small and mid-size publishers (such as those that may be represented by publishers 1202) to aggregate in order to drive higher yield for themselves. In an embodiment, publisher broker 1204 maintains a user interface through which it interacts with publishers 1202 and through which it manages publishers 1202's preferences.

In an embodiment, publisher broker 1204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed and what the publisher broker can expect in terms of a payment.

Architecture 1200 also comprises advertisers 1206. For purposes of explanation only, advertisers 1206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 1200.

In an embodiment, each advertiser purchases ad space on websites. For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 1206 is intended to represent any number of types, sizes, sophistication levels, etc. of advertisers. In an embodiment, advertisers 1206 desire to pay money to place ads on publishers 1202's websites.

Architecture 1200 also comprises advertiser broker 1208. For purposes of explanation only, only one advertiser broker will be discussed herein. However, embodiments of the present invention are not limited to a single advertiser broker, as any number of advertiser brokers may exist. In an embodiment, advertiser broker 1208 is an aggregator of advertisers. Specifically, advertiser broker 1208 is an entity that represents advertisers 1206 with the goal of optimizing advertisers 1206's spending and placing monetary values on displaying advertising of a particular format, on a particular website, to a particular audience. In an embodiment, advertiser broker 1208 maintains a user interface through which it interacts with advertisers 1206, and through which it manages advertisers 1206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 1200 also comprises exchange 1212. Exchange 1212 acts as a mediator between publisher broker 1204 and advertiser broker 1208. In an embodiment, exchange 1212 routes traffic and facilitates transactions, e.g., auctions, between publisher broker 1204 and advertiser broker 1208. In an embodiment, exchange 1212 is a server or a set of servers.

To provide minimum standards of conformity, in an embodiment, exchange 1212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 1212 sends all publisher broker requests that match a set of criteria defined by the advertiser broker, along with all relevant data about the request (e.g., the ask and collection symbols provided by the publisher and the exchange itself). In an embodiment, if the advertiser broker has any ads that it would like to have displayed and that meet the ask, it returns those ads, up to the number of ads requested, along with a CPI (cost per impression) bid on each. It is noted that CPM (cost per thousand impressions) and CPI are equivalent pricing models with different acronyms. However, embodiments are not limited to CPI pricing, as other pricing models may be used, e.g., CPC (cost per click), CPA (cost per acquisition), and revenue sharing. Exchange 1212 provides a call back to the winning advertiser broker(s) telling it which ads were displayed, and at what prices.

Architecture 1200 also comprises users 1214. For purposes of explanation only, only one user will be discussed herein. However, embodiments of the present invention are not limited to a single user, as any number of users may exist. Users 1214 request a webpage from publishers 1202. The webpage comprises content and advertisement space, which is filled with advertisement(s) from advertisers 1206.

Using architecture 1200, audience data can be provided to advertisers 1206 either by enriching the publishing property with customer intelligence or by acquiring the data directly from a data broker 1210 based on a licensing fee. For instance, advertiser broker 1208 can choose to pay an estimated monthly per volume amount for each attribute that their advertisers are interested in targeting. This transaction could be done off-line but would need to be registered with exchange 1212 to facilitate data rerouting at request time. Advertiser broker 1208 can base its bids on any targeting attributes provided by data broker 1210.

In an embodiment, when publishers 1202 have an impression that they are willing to sell (with an optional ask), they can provide a URL and any targetable values to exchange 1212. Exchange 1212 passes this data and possible additional user data from data broker 1210 to advertiser broker 1208. In an embodiment, advertiser broker 1208 ranks the bids of advertisers 1206 using any proprietary attributes or techniques that it finds useful. For example, advertiser broker 1208 could choose to run keyword extraction or categorization and use this for targeting. Advertiser broker 1208 would output a CPI ranked list of advertisers (in an embodiment, the number would be equal to the number of ads requested by the publisher). In an embodiment, where multiple advertiser brokers exist, exchange 1212 then ranks all ads across all advertiser brokers and chooses the best one (as measured by CPI). If these ads meet or exceed the publisher ask, then exchange 1212 proxies a display of the ads on the publisher website.

A second-price auction can still be applied to facilitate aggressive bidding. Publishers 1202 can be paid on a CPI basis. In an embodiment, exchange 1212 may be used to gate user information originating from publishers 1202. Publishers 1202 can choose to enrich their property with user data and share this information only with selected advertiser brokers.

Because publishers 1202 are concerned with user satisfaction, they would prefer to have some control over the relevancy of the ads placed on their site. Click-through rate is considered a good measure of relevance and therefore many publishers might want minimum click-through guarantees on the ads. Exchange 1212 allows publishers 1202 to optionally specify a minimum click-through rate that is acceptable. Exchange 1212 monitors advertiser broker 1208 to make sure that if it wins these types of asks, then it is meeting the performance guarantees. In an embodiment, if an advertiser broker consistently provides low click-through rates for publisher asks that require a minimum, exchange 1212 may take punitive measures such as suspension from the system.

Advertiser broker 1208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 1208 could multiply the conversion rate by the per conversion bid of the advertiser. The more information available in each request, the better job advertiser broker 1208 can potentially do in predicting the probability of a click or a conversion.

The entity hosting exchange 1212 has access to all data sources, giving it the power to make partial decisions. To alleviate the concern that exchange 1212 will not be impartial both as hosting body and as a direct participant, in an embodiment, transparency will be built into exchange 1212. In that embodiment, exchange 1212 does not have a way to identify brokers of any kind. Also, in that embodiment, advertiser auction algorithms and advertiser to publisher matching algorithms are standardized and transparent to all exchange participants. In an embodiment, no user identifiable information is sent to advertisers 1206 until the user performs an action. Exchange 1212 passes advertiser broker 1208 only the attribute values. Advertisers 1206 do not see the user identifier. At click-time, however, it is still possible for an advertiser to establish a user identifier and associate the bidding profile with that user. For example, exchange 1212 could require a linear value function, and advertisers 1206 would specify a base bid and a bid increment for each attribute value.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.”

Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Borders as a publisher has a user requesting the page on the “Lonely Planet Guide to Indonesia” and they would like to show ads on that page. They call exchange 1212 with the page URL and information about the user: “Bought four travel books in the last month,” “Bought a book on Bali in the last month,” and “Has clicked on ads before.”

Given the URL, exchange 1212 extracts keywords (“Bali vacations,” “Indonesia travel,” “exotic vacations,” “beach vacations”) and categories (“travel,” “vacations”), and sends this information to each advertiser broker. Each advertiser runs an auction for the impression. The advertiser broker can choose to ask for aggregate bids from advertisers. For example, Expedia might place an aggregate bid of 24 cents, and after subtracting the licensing fees, their base bid would be equal to 20 cents. Expedia's advertiser broker needs first to subtract all incremental bids and to assign credit to the publisher as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. The publisher was not able to assess the household income of the user so this incremental bid is not used. The 1 cent incremental bid for the search user patterns will be credited to MSNSearch. After the appropriate credit distribution the advertiser broker would assign a publisher value bid (the base bid+any incremental publisher bids) to each advertiser. In case of Expedia publisher value bid would be equal to 27 cents. Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad is served on Border's page. The user clicks on the ad. The user buys a two-week vacation to Bali.

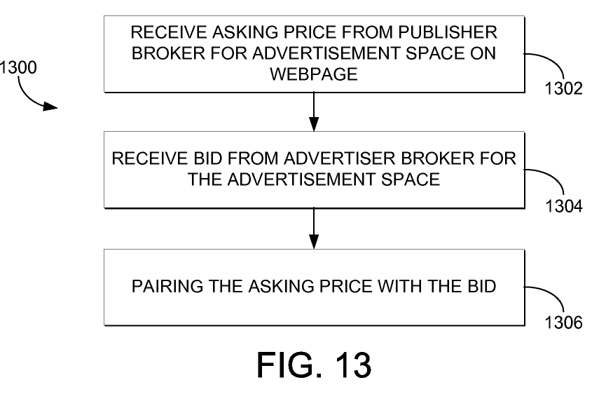

FIG. 13 illustrates a flowchart of the operation of an exchange, according to embodiments of the present invention. Referring to FIG. 13, method 1300 begins with the receipt of an ask from a publisher broker for advertisement space on a webpage (1302). A bid is received from an advertiser broker for the advertisement space (1304). In an embodiment, bids are received from many different advertiser brokers. The ask is paired with one of the bids (1306) and the advertisement space on the webpage is awarded to the winning bidder. As discussed in greater detail above, other information such as user attributes may be attached to the ask, and quality of the bidding advertisers may be examined prior to the advertisement space being awarded.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker.

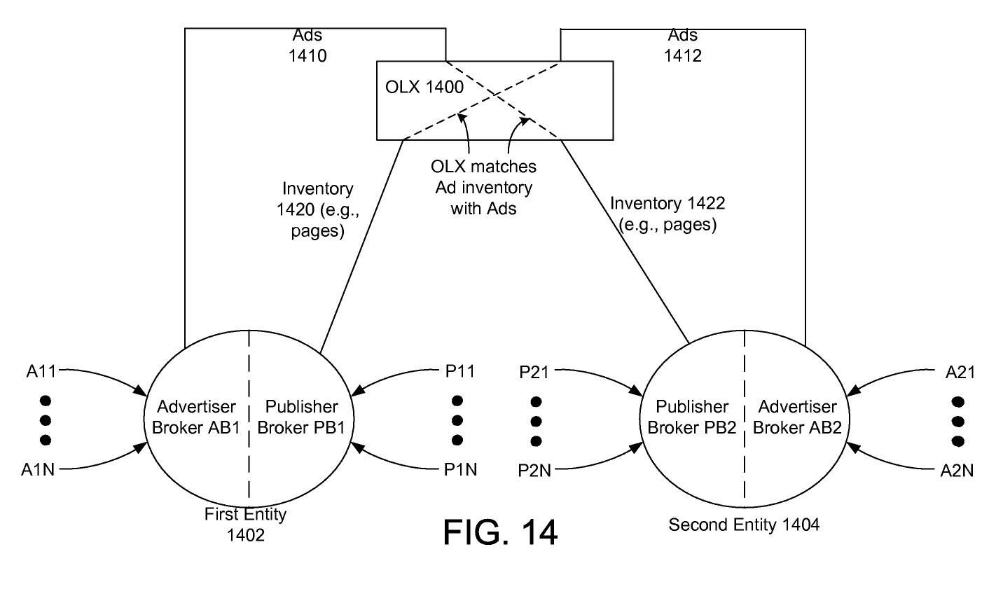

The invention thus can operate in a system that enables broad liquidity over distributed advertising markets, such as the above-described advertising exchange systems. FIG. 14 illustrates a conceptual block diagram of an on-line advertising exchange 1400 provided in accordance with the invention. As shown, a first entity 1402 and a second entity 1404 are subscribers to the services of exchange 1400. First entity 1402 may have an advertiser broker AB1 for brokering advertisements 1410 from a variety of sources A11 thru A1N and a publisher broker PB1 for brokering inventory 1420 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 1404 may have an advertiser broker AB2 for brokering advertisements 1412 from a variety of sources A21 thru A2N and a publisher broker PB2 for brokering inventory 1422 from a variety of publishers P21 thru P2N.

In accordance with the invention, by providing ads 1410 and 1412 to OLX 1400 according to a first communications layer, and by providing inventory 1420 and 1422 to OLX 1400 according to an independent communications layer, OLX 1400 can efficiently match advertisements to available inventory with greater simultaneous knowledge of multiple advertising networks.

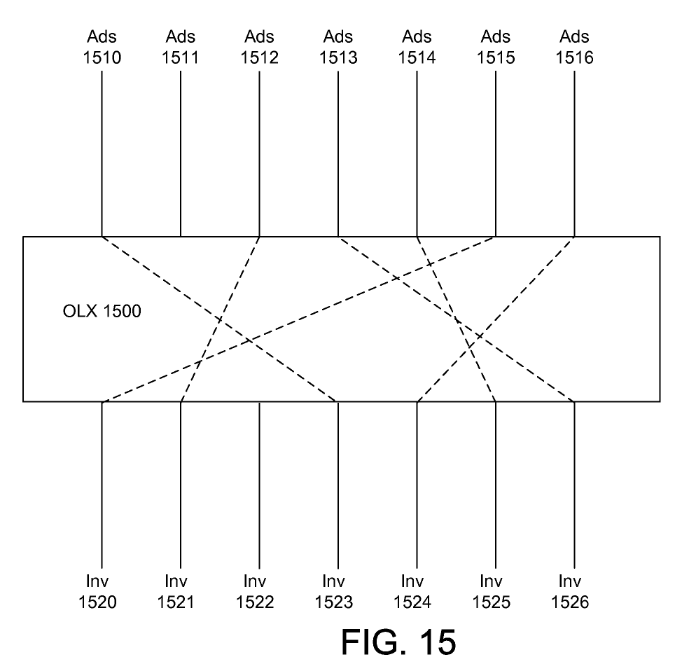

For instance, first entity 1402 might be Microsoft's MSN Web site, and second entity 1404 might be Yahoo's portal Web site. For simplicity, FIG. 14 illustrates only two entities, but advantageously, the invention can also be scaled to accommodate any number of advertising networks, e.g., eBay, Amazon, Google, etc. This is illustrated in FIG. 15 showing an OLX 1500 that accommodates a wide range of advertising 1510, 1511, 1512, 1513, 1514, 1515, 1516, etc. from a wide range of parties, and also accommodates a wide range of inventory 1520, 1521, 1522, 1523, 1524, 1525, 1526, etc. from a wide range of parties. OLX 1500 then makes the best assessment of how to match advertising content with inventory according to a variety of policies (e.g., maximizing ad revenue, maximizing quality of advertising, maximizing conversion rate, etc.). While various non-limiting embodiments of the invention are described in the context of two parties herein, this is for ease of conceptual presentation. It can be appreciated that the invention can be provided for any arbitrary number of advertising entities wishing to join the exchange 1500.

The invention may also be implemented in a peer-to-peer architecture, wherein processing performed by the exchange of the invention is shared across multiple participating machines. In such a non-limiting embodiment, each machine participating in the exchange network enabled by the invention can share some of the processing associated with normalization processes performed by the various embodiments of the on-line exchange of the invention.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described surpa, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method of facilitating trading of advertising, comprising:
receiving an ask from at least one publisher broker for an advertisement space, wherein the at least one publisher broker represents at least one publisher that received a request for publishing inventory from a user;
receiving a bid from at least one advertiser broker for the advertisement space, wherein the at least one advertiser broker represents at least one advertiser who desires to advertise advertisements to users, wherein at least one of the at least one publisher broker and at least one of the at least advertiser broker are from disparate advertising networks; and
initiating at least one transaction based on the ask and the bid and automatically defining at least one insurance term applicable to the at least one transaction.

2. The method of claim 1, further comprising:
automatically offering the at least one insurance term to the at least one publisher broker or publisher to accept in connection with the at least one transaction.

3. The method of claim 1, further comprising:
automatically offering the at least one insurance term to the at least one advertiser broker or advertiser to accept in connection with the at least one transaction.

4. The method of claim 1, wherein the defining includes automatically determining a risk specified by the at least one advertiser broker or at least one publisher broker.

5. The method of claim 1, wherein the defining includes automatically translating a risk determined to be associated with the at least one advertiser broker or the at least one publisher broker to the at least one insurance term.

6. The method of claim 1, further comprising:
receiving a specification of at least one constraint and translating the at least one constraint to the at least one insurance term.

7. The method of claim 1, further comprising receiving disparate expressions of risk from at least one publisher broker or at least one advertiser broker and normalizing the disparate expressions to a common way to express risk for direct comparison of the disparate expressions.

8. The method of claim 1, further comprising:
if a publisher broker or advertiser broker accepts the at least one insurance term, automatically applying the insurance terms to the transaction on behalf of the accepting party.

9. The method of claim 1, further comprising:
tracking performance of transactions as a function of insurance terms applying to those transactions.

10. A system to facilitate trading of advertising, comprising:
a publisher broker to represent at least one publisher, wherein the publisher broker determines at least one ask for an advertisement space of the at least one publisher;
an advertiser broker to represent at least one advertiser, wherein the advertiser broker manages at least one bid for the advertisement space by the at least one advertiser;
an exchange to facilitate at least one transaction for the advertisement space between the publisher broker and the advertiser broker, wherein the publisher broker and the advertiser broker are advertising entities of disparate advertising networks, and
at least one tool that receives from the publisher broker or the advertiser broker a specification of at least one risk expression applying to at least one transaction in the exchange, and wherein at least one insurance term for the at least one transaction is determined based on the at least one risk expression of the publisher broker or the advertiser broker.

11. The system of claim 10, wherein the exchange automatically determines and applies the at least one insurance term if the publisher broker or the advertiser broker accepts an offer according to the at least one insurance term.

12. The system of claim 10, wherein the tool determines a new set of at least one insurance terms when the at least one risk expression of the publisher broker or the advertiser broker is changed.

13. The system of claim 10, wherein the exchange automatically normalizes the at least one risk expression specified by the publisher broker or the advertiser broker to a common way to express risk within the exchange.

14. The system of claim 10, wherein the at least one tool receives a specification of a function of the quality of advertising involved in advertising transactions, and wherein the exchange automatically determines the at least one insurance term based on the function of the quality of advertising.

15. The system of claim 10, wherein the at least one tool receives a specification of a function of a size metric of other participants in advertising transactions involved in advertising transactions, and wherein the exchange automatically determines the at least one insurance term based on the function of the size metric.

16. The system of claim 10, wherein the at least one tool receives a specification of a function of display characteristics of the publishing inventory involved in advertising transactions, and wherein the exchange automatically determines the at least one insurance term based on the function of display characteristics.

17. The system of claim 10, wherein the at least one tool receives a specification of a function of the relevance of advertising involved in advertising transactions involved in advertising transactions, and wherein the exchange automatically determines the at least one insurance term based on the function of the relevance of advertising involved in advertising transactions.

18. The system of claim 10, wherein the at least one tool receives a specification of a function of the performance of advertising or publishing inventory involved in advertising transactions involved in advertising transactions, and wherein the exchange automatically determines the at least one insurance term based on the function of the performance of advertising or publishing inventory involved in advertising transactions.

19. The system of claim 10, further comprising:
an insurance provider that provides insurance services based on the at least one insurance term if the publisher broker or advertiser broker accepts the at least one insurance term.

20. A method for facilitating transactions for advertisement space in an advertising exchange between participants from the advertising side and/or the publishing side and from at least two disparate advertising networks, comprising:
receiving at least one utility function having an impact on a risk profile of a participant with respect to conducting at least one transaction in the advertising exchange;
soliciting offers from at least one insurance provider based on the risk profile and receiving a set of insurance terms applicable to the at least one transaction for offer to the participant; and
receiving acceptance of the set of insurance terms by the participant and conducting the at least transaction applying the set of insurance terms to the at least one transaction to reduce the risk represented by the risk profile for the at least one transaction.
